(19) United States
(12) Patent Application Publication
(10) Pub. No.: US 2005/0030319 A1
(43) Pub. Date: Feb. 10, 2005

(54) Method and apparatus for reducing the transmission requirements of a system for transmitting image data to a display device

(76) Inventors: Barinder Singh Rai, Surrey (CA); Atousa Soroushi, North Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/635,137

(22) Filed: Aug. 6, 2003

(51) Int. Cl. G09G 5/00

(52) U.S. Cl. 345/619

(57) ABSTRACT

The invention is directed to a method and apparatus for reducing the transmission requirements of a system for transmitting image data to a display device. The image data is stored in a memory. A portion of the image data is selected so that remaining image data is not selected. The selected portion of the image data is fetched from the memory while the remaining image data is not fetched from the memory.

The present invention relates to a method and apparatus for reducing the transmission requirements of a system for transmitting image data to a display device. More particularly, the invention relates to such a system adapted for displaying a main image and one or more ancillary images.

### BACKGROUND

Typically, video display systems include a CPU (central processing unit), a memory for storing video or pixel data produced by the CPU or some other source, such as a camera, and a display device, such as a CRT (cathode ray tube) or LCD (liquid crystal display) for displaying the pixels stored in the memory. Data from the memory is provided to the display device at a video “refresh” rate that is typically 60 frames, or display images, per second.

The memory used in the video display system is available in dynamic and static forms. Dynamic random access memory (“DRAM”) is less expensive and consumes less power than static random access memory (“SRAM”) and is therefore desirable as it saves on hardware and operating costs. However, in certain circumstances, DRAM is slower than SRAM. This occurs, for example, when the memory accesses in the system are generally directed to various addresses, that is, for a given series of memory accesses, the addresses are variable rather than sequential. When several devices in the system share the same memory, memory accesses tend to be directed to various, non-sequential addresses (“random addresses”), and DRAM tends to be slower than SRAM. In a video display system, it is common to have several devices which share the same memory and the use of DRAM imposes a limitation on the system because of the finite transmission capacity or “bandwidth” of the DRAM memory. Particularly, where SRAM is clocked at a rate “MClock,” only two clock cycles are typically needed to read from or write to the memory, regardless of the memory location being addressed. By contrast, five clock cycles are typically needed to access random memory addresses in DRAM. For example, to read 128 bytes of data from random addresses in the DRAM memory would generally require 640 clock cycles. Accordingly, use of DRAM as the memory in video display systems was very inefficient.

It was recognized, however, that while five clock cycles were consumed in accessing data using separate reads or writes, only one clock cycle was required to access data at adjacent locations in what is known as “burst mode.” Further, while different devices tend to access memory at random addresses, each device often makes a sequence of accesses and frequently the addresses in the sequence are adjacent. Therefore, it was recognized that the effective bandwidth of the DRAM could be increased greatly by providing a buffer between the DRAM and the display device, and burst reading the memory to fill the buffer. For example, while five clock cycles are needed to read the first of 128 bytes of data, only one clock cycle is needed to consecutively read each of the next 127 bytes of data, so that only 132 clock cycles are needed to read all of the 128 bytes. Typically, the buffer is organized in FIFO (first-in, first-out) form, and is referred to herein as a “pipe.”

While the use of the pipe increased DRAM memory bandwidth to the point that DRAM can approach the performance of SRAM in the video display system, memory bandwidth remains limited because the memory serves other requestors. For example, the video display system typically displays, in addition to a “main” image (defined herein as an image substantially filling the entire display), a number of ancillary images such as the cursor, one or more overlay images, one or more picture-in-picture (“PIP”) images, and one or more 2D block function images. The ancillary images overlay the main image, and overlay each other, according to a programmed priority.

The main image and each of the ancillary images is typically provided with its own pipe. However, only one pixel can be displayed at a given pixel location on the display device. Therefore, the display device includes an interface for selecting the pipe from which to read the selected pixel for each pixel location on the display device. The pixels in the remaining pipes for the same pixel location are not read from those pipes and are not displayed.

In addition to the demands placed on the DRAM by the main and ancillary images, there are additional demands such as those made by the CPU and peripheral devices, such as cameras, that limit available memory bandwidth. When the bandwidth is exceeded, pixels cannot be obtained from the DRAM memory fast enough to keep all of the pipes full, and either the main image or the ancillary images, or both, become corrupted. Previously, when these limits were exceeded, the user was required to accept this corruption, or limit the size of the images, so that less data was required to service or refresh the images.

Accordingly, there is a need for a method and apparatus for reducing the transmission requirements of a system for transmitting image data to a display device beyond those of the prior art.

### SUMMARY OF THE INVENTION

Within the scope of the invention, the application discloses a method and apparatus for reducing the transmission requirements of a system for transmitting image data to a display device, the image data being stored in a memory. A portion of the image data is selected so that remaining image data is not selected. The selected portion of the image data is fetched from the memory while the remaining image data is not fetched from the memory.

Where the image data includes main image data and overlay image data having a second portion that overlaps the main image data, a first portion of the image data is selected from the main image data. The remaining image data includes main image data corresponding to the second portion of the overlay image data.

Additional objects, features and advantages of the invention will be more readily understood upon consideration of the following detailed description of the invention, taken in conjunction with the following drawings.

### BRIEF SUMMARY OF THE DRAWINGS

FIG. 1 is a schematic view of a preferred system for transmitting image data to a display device incorporating principles of the invention.

FIG. 2 is a pictorial view of the display device of FIG. 1 for displaying main and overlay image data.

FIG. 3 is a schematic view of the contents of main and overlay image display pipes of FIG. 1.

### DETAILED DESCRIPTION OF PREFERRED EMBODIMENTS

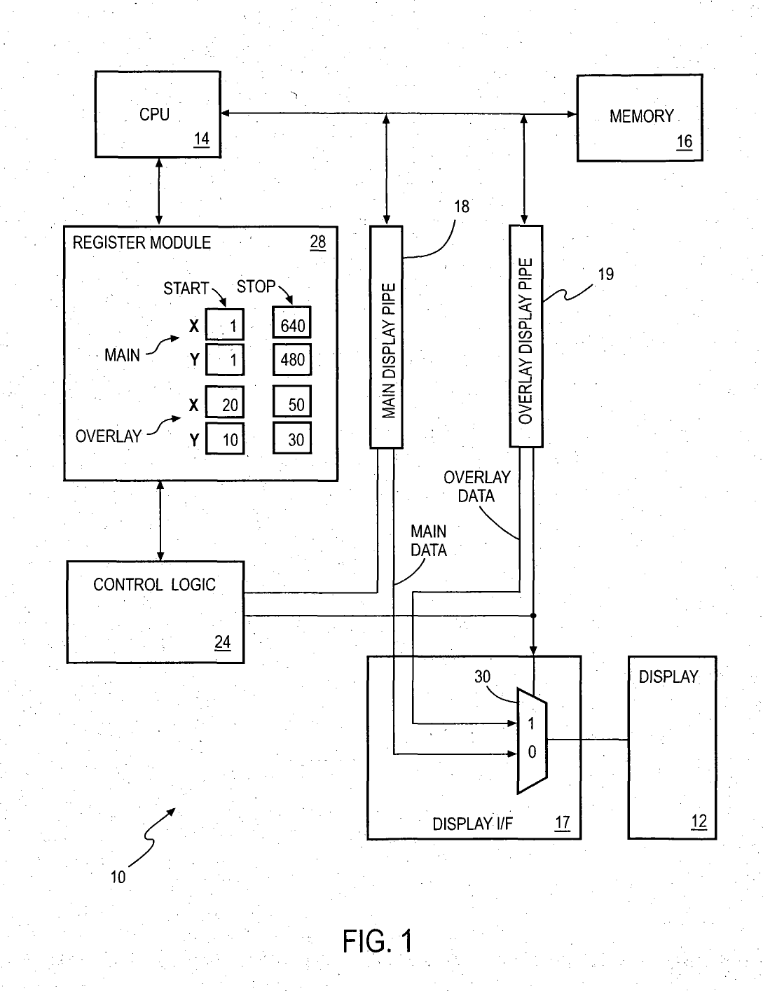

Reference will now be made in detail to the present preferred embodiments of the invention, examples of which are illustrated in the accompanying drawings. Wherever possible, the same reference numbers are used in the drawings and the description to refer to the same or like parts. A preferred system 10 for transmitting image data to a display device incorporating principles of the present invention is shown in FIG. 1. The system 10 is particularly adapted to transmit at least two types of image data referred to herein as “main” image data and “overlay” image data to a display device 12, such as an LCD, to produce a viewable image. The invention may be employed in conjunction with transmitting image data in any display system, however, and the principles of the invention may be used in other contexts where desired.

The system 10 includes a display device 12, a CPU 14, a memory 16, a display interface 17, and two display pipes 18 and 19 for buffering the main image data and the overlay image data, respectively. Preferably, the memory is DRAM, but this is not essential. Other types of memory, such as SRAM, may be employed. The memory 16 may be embedded memory on a graphics controller or other chip, or may be one or more separate memory chips. For clarity of illustration, the exemplary system 10 has just two pipes, however, it is contemplated that a system according to the invention may have three or more pipes. In one preferred embodiment, the system 10 includes a pipe for the main image and a pipe for each of a plurality of ancillary images, including a cursor pipe, a plurality of overlay image pipes, a plurality of PIP pipes, and a plurality of 2D block function image pipes. Preferably, the display pipes 18, 19 are FIFO buffers (which may be thought of as shift registers) that fetch data from the memory 16 at a memory clocking frequency MClock, which may be, for example, 100 MHz.

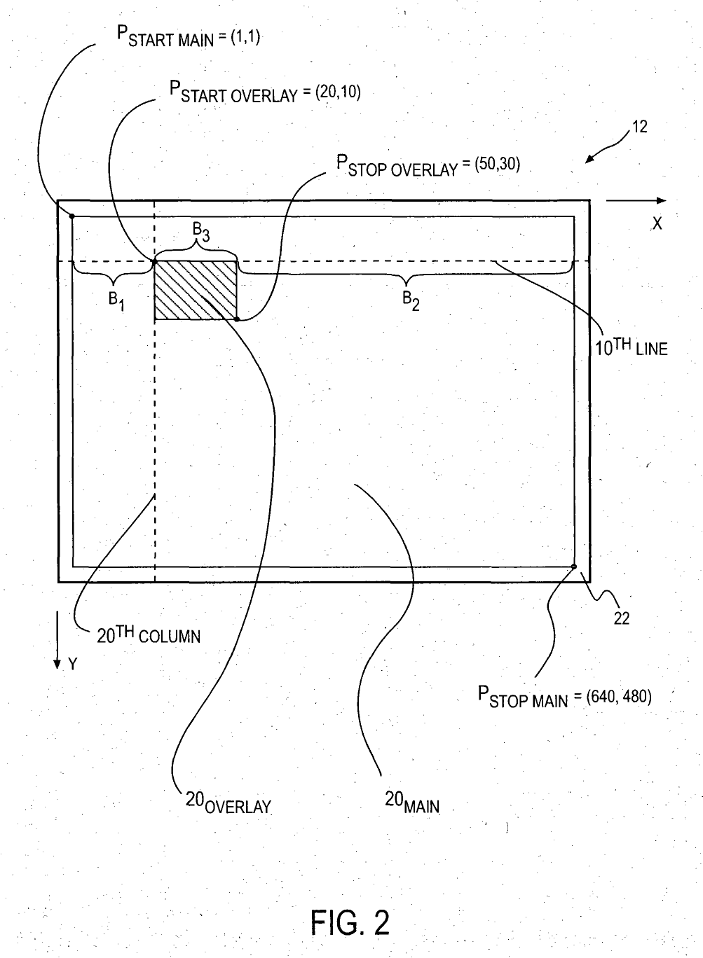

FIG. 2 shows the display device 12 which includes at least one display screen 22. The display pipe 18 fetches data in the memory 16 corresponding to a main display image 20ₘₐᵢₙ and the display pipe 19 fetches data in the memory 16 corresponding to an overlay image 20_{overlay}. The overlay image 20_{overlay} overlays or is displayed on top of the main image 20ₘₐᵢₙ. The overlay image 20_{overlay} typically occupies a smaller portion of a display screen 22 than the main image 20ₘₐᵢₙ, but this is not necessary. Wherever the overlay image 20_{overlay} is displayed, the main image 20ₘₐᵢₙ is not displayed. Like the display pipes in FIG. 1, only two display images are shown for clarity of illustration. It is contemplated, however, that the display screen 22 according to the invention may have a main image and two or more ancillary images.

In addition to fetching data from the memory 16, the display pipes 18, 19 provide the data to the display 12. The display pipes 18, 19 provide these data at a display or pixel clocking frequency P_{clock} that may be, for example, 30 MHz, which depends on the number of pixels on the display screen 22. In that regard, the data may be provided as complete pixels or as color components of pixels.

The display pipes 18, 19 buffer the CPU 14 and the memory 16 from the display 12, by permitting the CPU to fill the display pipes with data at a relatively high speed, while the pipes can be emptied of data at the relatively lower speed required by the display. In that regard, the display pipes 18, 19 preferably include one or more flags indicating whether the pipes are almost full or almost empty. If a pipe 18, 19 is almost full, its priority for accessing the memory 16 may be downgraded as compared to the situation in which the pipe is almost empty. However, providing such flags is not essential to the invention.

The system 10 further includes control logic 24 to control the operation of the display pipes 18, 19. The CPU 14 instructs the control logic 24 through a register module 28 that includes information specifying the coordinates for starting (X_{start main,} Y_{start main}) and stopping (X_{stop main}, Y_{stop main}) the display of the main image 20ₘₐᵢₙ and the starting and stopping points (X_{start overlay}, Y_{start overlay}) and (X_{stop overlay}, Y_{stop overlay}) for an overlay image 20_{overlay} overlaying the main image. These points correspond to pixel locations on the display screen 22 where the “starting” and “stopping” terminology is illustrative of where the data are raster scanned, as is typical in the art, though this is not essential. Moreover, while the images are typically rectangular, they may be any shape, and their locations on the display screen 22 may be defined by two points, or one point in conjunction with a specified inclination.

In the example shown in FIGS. 1 and 2, the exemplary main image 20ₘₐᵢₙ starts at starting coordinate (X=1, Y=1), corresponding to a pixel P_{start main} at the intersection of a first line and a first column of the display screen 22, and stops at stopping coordinate (X=640, Y=480), corresponding to a pixel P_{stop main} at the intersection of the 480th line and the 640th column of the display screen 22. The exemplary overlay image 20_{overlay} starts at starting coordinate (X=20, Y=10), corresponding to a pixel P_{start overlay} at the intersection of the 10th line and the 20th column of the display screen 22, and stops at stopping coordinate (X=50, Y=30), corresponding to a pixel P_{stop overlay} at the intersection of the 30th line and the 50th column of the display screen 22.

The main image 20ₘₐᵢₙ will not be displayed within the space allocated on the display screen 22 to the overlay image 20_{overlay}. It is an outstanding feature of the invention to discriminate between the main and overlay image data within this space and not fetch the main image data from the memory 16 corresponding to this space in order to reduce the transmission requirements of the system, for example, to free the memory for accesses by other resources which increases bandwidth and/or increases transmission speed.

The control logic 24 acquires location-defining information for each image which is stored in the register module 28, and therefore, “knows” what main image 20ₘₐᵢₙ data should be displayed, and what main image data underlies the overlay image 20_{overlay} and should not be displayed. The control logic enables the pipe 18 to fetch only the data from the memory 16 that corresponds to locations on the display screen 22 where the main image 20ₘₐᵢₙ is to be displayed. Main image data is not fetched from memory 16 if it corresponds to locations on the display 22 where the overlay image 20_{overlay} is to be displayed.

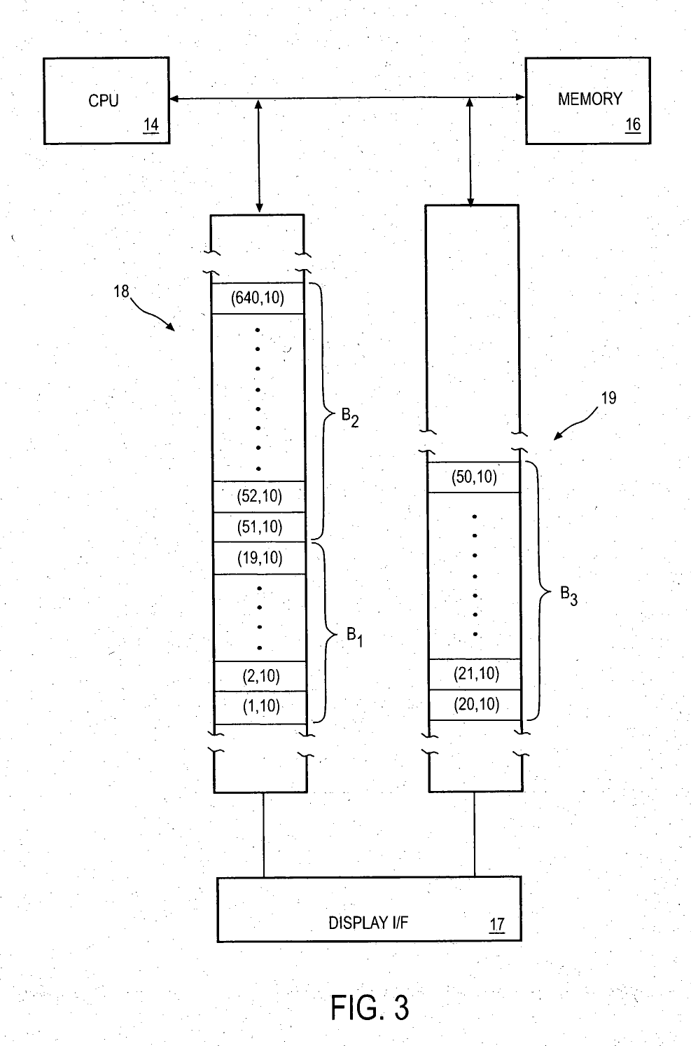

An example explaining how data for the 10^{th} line of the display 22 is fetched, based on FIGS. 1 and 2 illustrates the operation of the control logic 24. The main display pipe 18 is enabled by the control logic 24 to fetch main image data corresponding to a first block B₁ of the 19 pixels (1, 10), (2, 10), . . . (19, 10), and a second block B₂ of the 590 pixels (51, 10), (52, 10), . . . (640, 10) of the display 22. However, the main display pipe 18 does not fetch main image data corresponding to the 31 pixels (20, 10), (21, 10), . . . (50, 10). The main display pipe 18 would therefore have the contents shown in FIG. 3, where the main display pipe 18 has a 640 pixel storage capacity for simplicity of illustration. In a preferred embodiment, the main display pipe 18 has only a 128 pixel storage capacity, so that only a portion of the second block B₂ would be fetched along with the block B₁.

Having fetched the data for the main image 20ₘₐᵢₙ for the 10th line of the display screen from the memory 16, the control logic enables the overlay display pipe 19 to fetch the data for the overlay image 20_{overlay} corresponding to a third block B₃ of the 31 pixels (20, 10), (21, 10), . . . (50, 10) for the 10th line. The overlay display pipe 19 would have the contents shown in FIG. 3.

To display the data blocks B₁-B₃ of the 10th line of the display screen 22, the control logic 24 clocks the data out of the appropriate display pipe 18, 19 while counting the data, and switches between the corresponding outputs of the display pipes via a multiplexer 30 that is preferably a component of the display interface 17. In the example above, the control logic 24 switches the multiplexer 30 to select the output of the main display pipe 18 to provide the first block B₁ of the main image data stored therein to the display device 12. The first block B₁ contains 19 pixels and the data are clocked from the main display pipe 18 until a count of 19 clock cycles has been reached. Then, the control logic 24 switches the multiplexer 30 to select the overlay display pipe 19 to provide the third block B₃ of overlay image data stored therein to the display device 12. The third block B₃ contains 31 pixels and the data are clocked from the overlay display pipe 19 until a count of 31 clock cycles has been reached. Finally, the control logic 24 switches the multiplexer 30 back to select the main display pipe 18 to obtain the second block B₂ of main image data and complete the 10th line of the display.

The operation of control logic 24 is the same for the other lines of the display 22. The control logic 24 may be implemented in various ways in accord with the principles illustrated by the example given above, in hardware or software, as will be immediately apparent to persons of ordinary skill. Similarly, the switching function performed by multiplexer 30 may be implemented in various ways. Preferably, the switching function is performed within the display interface 17, but this is not essential.

It is to be recognized that, while a specific method and apparatus for reducing the transmission requirements of a system for transmitting image data to a display device has been shown and described as preferred, other configurations and methods could be utilized, in addition to those already mentioned, without departing from the principles of the invention. In the example described herein, the main display pipe 18 fetches main display data from memory 16 before the overlay display pipe 19 fetches overlay display data, however, the order in which data is fetched is not important to the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims that follow.

1. A method for reducing the transmission requirements of a system for transmitting image data stored in a memory to a display device, the method comprising the steps of:
selecting a first portion of the image data so that remaining image data is not selected;
fetching the selected portion of the image data from the memory; and
not fetching the remaining image data from the memory.

2. The method of claim 1, wherein the image data includes main image data and overlay image data having a second portion that overlaps the main image data, and wherein said step of selecting said first portion of the image data selects from the main image data and wherein said remaining image data includes main image data corresponding to said second portion of said overlay image data.

3. An apparatus for reducing the transmission requirements of a system for transmitting image data stored in a memory to a display device, comprising:
a processor for selecting a first portion of the image data so that remaining image data is not selected;
a first display pipe; and
control logic adapted to cause said first display pipe to fetch the selected portion of the image data from the memory and not to fetch the remaining image data from the memory.

4. The apparatus of claim 3, wherein the image data includes main image data and overlay image data having a second portion that overlaps the main image data, wherein said processor is adapted to select said first portion of the image data from the main image data and store said first portion in said first display pipe, and wherein said remaining image data includes main image data corresponding to said second portion of said overlay image data.

5. The apparatus of claim 4, further comprising a second display pipe, wherein said control logic is adapted to switch from said first display pipe to said second display pipe to obtain said second portion of the overlay image data.

6. The apparatus of claim 5, wherein said processor is adapted to provide said control logic location-defining information for said main image data and said overlay image data, and wherein said control logic is adapted to switch between said first and second display pipes according to said location-defining information.
